(19) United States
(12) Patent Application Publication
(10) Pub. No.: US 2024/0259421 A1
(43) Pub. Date: Aug. 1, 2024

(54) SYSTEM AND METHOD TO MITIGATE DISTRIBUTED DENIAL OF SERVICE (DDoS) ATTACKS

(71) Applicants: Naveen Kumar SHARMA, Jaipur (IN); Apurv BORDIA, Jaipur (IN)

(72) Inventors: Naveen Kumar SHARMA, Jaipur (IN); Apurv BORDIA, Jaipur (IN); Kiran SHARMA, Jaipur (IN); Nupur BORDIA, Jaipur (IN); Shankar Ganesh Pillaiyar Nattamai Jeyaprakash, Bangalore (IN)

(21) Appl. No.: 18/423,359

(22) Filed: Jan. 26, 2024

(30) Foreign Application Priority Data
Jan. 26, 2023 (IN) 202211042862

(51) Int. Cl. H04L 9/40

(52) U.S. Cl. CPC H04L 63/1458; H04L 63/1425

(57) ABSTRACT

Disclosed is a system (100) comprising a plurality of nodes (102) configured to (i) exchange node information with one another, (ii) determine a reconstruction error from the node information associated with each node, and (iii) determine a set of traffic anomalies for a first set of nodes (102a) of the plurality of nodes (102) having the reconstruction error higher than a first threshold value, a second set of nodes (102a) are configured to (i) select a predetermined attack pattern from a set of predetermined attack patterns for each traffic anomaly having a similarity score higher than a second threshold value, (ii) generate an new attack pattern for each traffic anomaly having the similarity score less than the second threshold value, and (iii) segregate genuine traffic from overall traffic at the first set of nodes (102a) using one of, the set of predetermined attack patterns and the new attack pattern.

### RELATED FIELD

The present disclosure relates generally to systems and/or methods for enhancement of the security and productivity of a network. More particularly, the present disclosure relates to a system and method to mitigate Distributed denial of service (DDOS) attack.

### BACKGROUND

Malicious hackers divert massive traffic and requests to a website or data centre, slowing down the internet by excessive usage of bandwidth, thus making the bandwidth unavailable for legitimate users this slowing down of the internet is known as distributed denial of service (DDoS). A DDOS attack disrupts the normal traffic flow of a targeted server, network, or services by flooding the target or its surrounding infrastructure with massive traffic or requests, exceeding its handling capacity the network that causes the internet to slow down inside the data centre.

Commonly used systems and methods for monitoring and mitigation of DDOS attacks are based on availability based, distributed architecture, access management and traffic control, However, all the above-mentioned systems and methods result in high maintenance cost of system and compromised security of the network.

Thus, an inexpensive and secure system, and method for protection of each node in the network, prevention and mitigation of DDOS attacks to each node in the network is an ongoing effort and demands a need for improvised technical solution that overcomes the aforementioned problems.

### SUMMARY

To address the abovementioned challenges, disclosed is a system to mitigate distributed denial of service (DDOS) attacks. The system includes a plurality of nodes configured to (i) exchange node information with one another, (ii) determine a reconstruction error from the node information associated with each node of the plurality of nodes, and (iii) determine a set of traffic anomalies for a first set of nodes of the plurality of nodes having the reconstruction error higher than a first threshold value. The plurality of nodes includes a second set of nodes that are configured to (i) select a predetermined attack pattern from a set of predetermined attack patterns for each traffic anomaly from the set of traffic anomalies having a similarity score higher than a second threshold value, (ii) generate an new attack pattern for each traffic anomaly of the set of traffic anomalies having the similarity score less than the second threshold value, and (iii) segregate genuine traffic from overall traffic that is diverted at the first set of nodes using one of, the set of predetermined attack patterns and the new attack pattern.

In some aspects of the present disclosure, to segregate the genuine traffic from the traffic at the first set of nodes, the plurality of nodes is configured to update the set of predetermined attack patterns by adding the new attack pattern to the set of predetermined attack patterns.

In some aspects of the present disclosure, the plurality of nodes are further configured to (i) obtain first regular data, (ii) generate low dimensional data from the first regular data, (iii) generate second regular data from the low dimensional data, (iv) determine an training reconstruction error by comparing the first regular data with the second regular data, and (v) iteratively adjust a set of weights of the plurality of nodes for reducing a value of the training re-construction error below a third threshold value using one or more artificial intelligence (AI) techniques.

In some aspects of the present disclosure, the plurality of nodes are segregated into the first and second set of nodes based on node information associated with each node of the plurality of nodes.

In some aspects of the present disclosure, to generate the similarity score, the second set of nodes is configured to compare the traffic anomaly of each node of the first set of nodes with each attack pattern of the set of predetermined attack patterns.

In another aspect of the present disclosure, a method for mitigating distributed denial of service (DDOS) attacks. The method includes steps of exchanging, by way of a plurality of nodes (102), node information within each other, determining, by way of the plurality of nodes (102), a reconstruction error from the node information associated with each node of the plurality of nodes (102), determining, by way of the plurality of nodes (102), a set of traffic anomalies for a first set of nodes (102a) of the plurality of nodes (102) having the reconstruction error higher than a first threshold value, selecting, by way of a second set of nodes (102b), a predetermined attack pattern from a set of predetermined attack patterns for each traffic anomaly from the set of traffic anomalies having a similarity score higher than a second threshold value, generating, by way of the second set of nodes, an attack pattern for each traffic anomaly of the set of traffic anomalies having the similarity score less than the second threshold value, and segregating, by way of the second set of nodes, genuine traffic from overall traffic that is diverted at the first set of nodes using the set of predetermined attack patterns.

### BRIEF DESCRIPTION OF THE DRAWINGS

Other objects, features, and advantages of the aspect will be apparent from the following description when read with reference to the accompanying drawings. In the drawings, wherein like reference numerals denote corresponding parts throughout the several views:

The diagrams are for illustration only, which thus is not a limitation of the present disclosure, and wherein:

FIG. 1 illustrates a block diagram of a system to mitigate distributed denial of services (DDOS) attacks, in accordance with an exemplary aspect of the present disclosure;

FIG. 2 illustrates a block diagram of a first node of a first set of nodes of the system to mitigate DDOS attacks of FIG. 1, in accordance with an exemplary aspect of the present disclosure;

FIG. 3 illustrates a block diagram of a first node of a second set of nodes of the system to mitigate DDOS attacks of FIG. 1, in accordance with an exemplary aspect of the present disclosure; and

FIGS. 4A-4B illustrate a flow diagram of a method for mitigating DDOS attacks, in accordance with an exemplary aspect of the present disclosure.

To facilitate understanding, like reference numerals have been used, where possible to designate like elements common to the figures.

### DETAILED DESCRIPTION OF THE PREFERRED ASPECTS

The aspects herein and the various features and advantageous details thereof are explained more fully with reference to the non-limiting aspects that are illustrated in the accompanying drawings and detailed in the following description. Descriptions of well-known components and processing techniques are omitted so as to not unnecessarily obscure the aspects herein. The examples used herein are intended merely to facilitate an understanding of ways in which the aspects herein may be practiced and to further enable those of skill in the art to practice the aspects herein. Accordingly, the examples should not be construed as limiting the scope of the aspects herein.

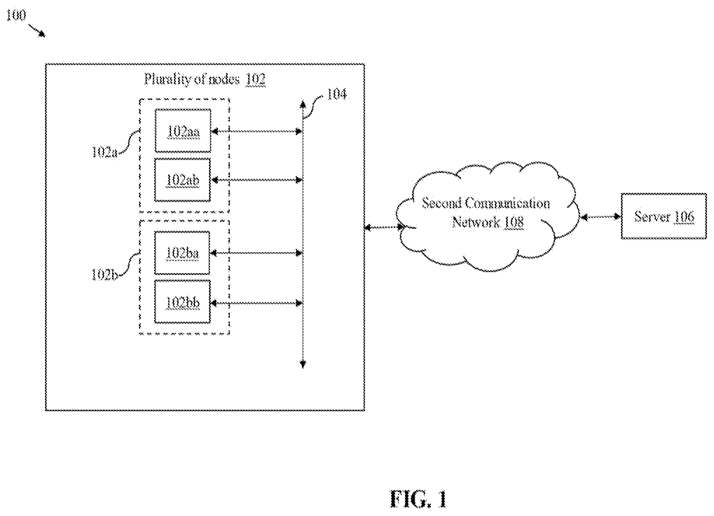

FIG. 1 illustrates a block diagram of a system 100 to mitigate distributed denial of services (DDOS) attacks, in accordance with an exemplary aspect of the present disclosure. The system 100 to mitigate distributed denial of services (DDOS) attacks (hereinafter interchangeably referred to and designated as “the system 100”) may be configured as a distributed public blockchain and may allow new nodes and/or new users to be added to the distributed blockchain network. The system 100 may further facilitate one or more nodes on the distributed blockchain network with high level of data security, transparency, immutability and traceability. In some aspects of the present disclosure, the system 100 may further facilitate a user (joined as a node) to select specific requirements of service, location and nodes available in the distributed blockchain network for opting one or more services. Further, the system 100 may include one or more protocols for route origin authorization (ROA) and route origin validation (ROV) for origination of a route for service and validation of the route of the service.

The system 100 may include a plurality of nodes 102 such that each node of the plurality of nodes 102 is communicatively coupled to each of the other nodes of the plurality of nodes 102 by way of a first communication network 104. In some aspects of the present disclosure, when a user registers into the system 100 to act as a node, the system 100 prompts the user to select a role that the user wants to play in the system 100. The role may be one of, a consumer of a service and a contributor in community to make safer internet of trust. The user may provide node information through a registration menu (not shown) displayed through a user device associated with the user. The node information may include, but is not limited to, a selected role (i.e., a consumer of a service and a contributor) traffic data, a category of service, a computation capability, a storage capability, and the like. Aspects of the present disclosure are intended to include and/or otherwise cover any type of the node information associated with a node of the plurality of nodes 102, known to a person having ordinary skill in the art, without deviating from the scope of the present disclosure. Specifically, based on the node information the plurality of nodes 102 may be segregated into first and second set of nodes 102a and 102b i.e., the first set of nodes 102a are the nodes with selected role of a consumer and the second set of nodes 102b are the nodes with the selected role of a contributor. In some aspects of the present disclosure, the system 100 may be further configured to enable the user to create a login identifier and a password that may enable the user to subsequently login into the system 100. The system 100 may be configured to store the node information associated with the user, the login and the password associated with the user in a Look Up Table (LUT) (not shown) provided in a database (not shown).

In some aspects of the present disclosure, each node of the plurality of nodes 102 may be configured to operate cooperatively as a distributed network by sharing computation and storage resources over the first communication network 104. The system 100 may further include a server 106 communicatively coupled to the plurality of nodes 102 by way of a second communication network 108. In some aspects of the present disclosure, the first communication network 104 and the second communication network 108 may be a part of a single communication network (not shown), such that each node of the plurality of nodes 102 may be communicatively coupled to each other node of the plurality of nodes 102 and the server 106 by way of the single communication network.

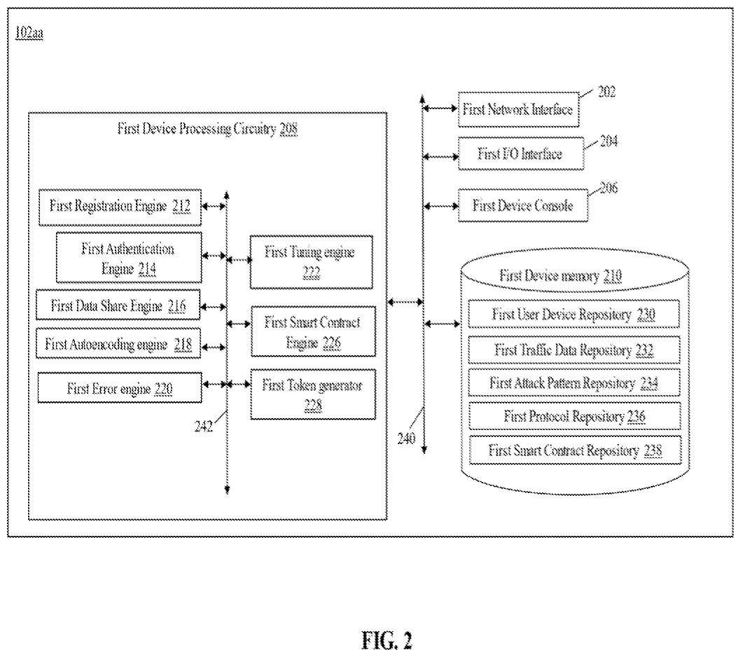

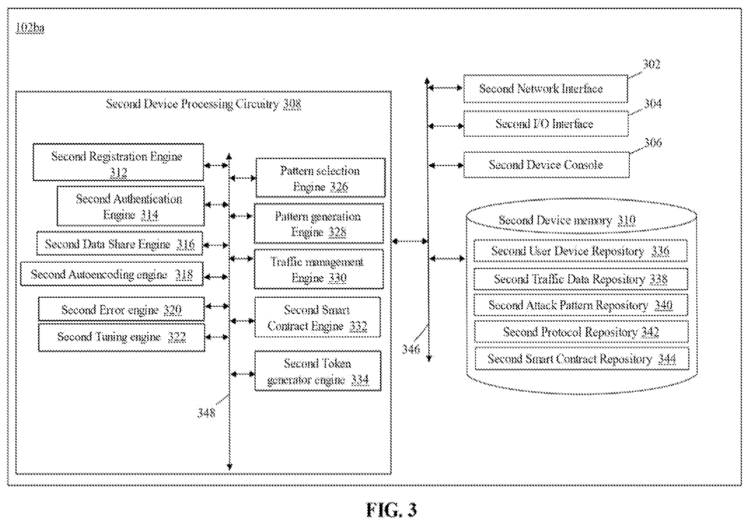

In some aspects of the present disclosure, each node of the plurality of nodes 102 may be configured to receive first regular data corresponding to a plurality of categories of service (hereinafter interchangeably referred to and designated as ‘regular data’). The first regular data may be inferred to as a regular traffic data corresponding to a specific category of service of the plurality of categories of service and may be different for each category of service of the plurality of categories of service. For example, for a category of service ‘X1’, the regular traffic data may be 1000 units per day, and for another category of service ‘X2’ the regular traffic data may be 100000 units per day. In some aspects of the present disclosure, the plurality of nodes 102 may be configured to fetch the first regular data for the plurality of categories of service from a distributed ledger (not shown, that may be operationally similar to “a first device memory 210” and/or “a second device memory 310” of FIG. 2 and FIG. 3, respectively), that may be shared by the plurality of nodes 102. In other aspects of the present disclosure, the plurality of nodes 102 may obtain the regular data from an external source (such as an external server).

In some aspects of the present disclosure, the plurality of nodes 102 may be configured to determine a training reconstruction error from the first regular data. To train an autoencoding engine executable at each node of the plurality of nodes 102, the plurality of nodes 102 by way of the autoencoding engine may generate a low dimensional data from the first regular data. Further, the plurality of nodes 102 by way of the autoencoding engine may generate a second regular data from the low dimensional data such that the first regular data is compared with the second regular data. Specifically, the plurality of nodes 102 may be configured to compute the training reconstruction error based on the comparison of the first regular data with the second regular data. Further, each node of the plurality of nodes 102 may be configured to iteratively update a plurality of parameters of the autoencoding engine associated with that node until the training reconstruction error value becomes less than a third threshold value. For example, each node of the plurality of nodes 102 may be configured to iteratively update the plurality of parameters of the autoencoding engine associated with that node until the training reconstruction error value becomes less than 5%, thus giving an accuracy of 95% for the trained autoencoding engine. In some aspects of the present disclosure, the plurality of nodes 102 may be configured to iteratively update the plurality of parameters of the autoencoding engine of each node of the plurality of nodes by way of one or more artificial intelligence (AI) techniques.

The plurality of nodes 102 may be configured to exchange the node information with one another (i.e., each node of the plurality of nodes 102 share the node information with each of the other node of the plurality of nodes 102). As discussed, the node information associated with each node of the plurality of nodes 102 may include, but is not limited to, traffic data, a category of service, a computation capability, a storage capability, a selected role, and the like. Aspects of the present disclosure are intended to include and/or otherwise cover any type of the node information associated with a node of the plurality of nodes 102, known to a person having ordinary skill in the art, without deviating from the scope of the present disclosure. The plurality of nodes 102, by way of the trained autoencoding engine of each node may further be configured to determine a reconstruction error for each node of the plurality of nodes 102. Specifically, the reconstruction error may be determined based on the node information associated with each node of the plurality of nodes 102. Further, the plurality of nodes 102 may be configured to identify one or more nodes of the first set nodes 102 having the reconstruction error higher than a first threshold value such that the plurality of nodes 102 determines a traffic anomaly for each identified node of the first set of nodes 102a.

Further, each node of the first set of nodes 102a may be configured to share a set of anomalies including the traffic anomaly to the plurality of nodes 102. Specifically, the traffic anomaly may be determined based on, but not limited to, a number of requests from a single source, a rate of connection requests, and unusual traffic patterns, and the like. In some aspects of the present disclosure, the second set of nodes 102b may be configured to select an attack pattern from a set of predetermined attack patterns for each of the traffic anomaly from the set of anomalies that may have a similarity score higher than a second threshold value. In some aspects of the present disclosure, to generate the similarity score, the second set of nodes 102b may be configured to compare the traffic anomaly of each node of the first set of nodes 102a with each attack pattern of the set of predetermined traffic patterns. The second set of nodes 102b may further be configured to generate a new set of attack pattern that includes a new attack pattern for each traffic anomaly from the set of anomalies that has the similarity score less than the second threshold value. Further, the second set of nodes 102b may be configured to generate a set of updated attack patterns by adding the new set of attack patterns to the set of predetermined attack patterns and may share the set of updated attack patterns to the plurality of nodes 102. In some aspects of the present disclosure, the second set of nodes 102b may be configured to segregate genuine traffic from overall traffic on each node of the first set of nodes 102a using the set of updated attack patterns. Further, the second set of nodes 102b may be configured to generate an alert signal such that the alert signal includes the details of unauthentic traffic. Furthermore, the second set of nodes 102b may be configured to provide the alert signal to the corresponding node of the first set of nodes 102a such that the first set of nodes 102a can take appropriate action to either block and/or flag the unauthentic traffic based on the alert signal. In an exemplary scenario, the first set of nodes 102a may be configured to automatically implement throttling rules to limit the impact of the DDOS attack in response to the alert signal by limiting requests from certain IP addresses and/or slowing down traffic from suspicious sources. Further, the first set of nodes 102a may dynamically update a blacklist of sources identified as origins of malicious traffic such that the blacklist is further shared across the plurality of nodes 102 in the network to preemptively protect nodes from identified DDOS attacks. Specifically, the segregation of the genuine traffic from the overall traffic may result in mitigation of DDOS attacks on each node of the first set of nodes 102a. It will be apparent to a person skilled in the art that the above example is for illustration only and thus must not be considered as a limitation of the present disclosure.

The plurality of nodes 102 (as shown in FIG. 1) are shown to include two nodes in the first set of nodes 102a (i.e., first and second nodes 102aa and 102ab) and two nodes in the second set of nodes 102b (i.e., first and second nodes 102ba and 102bb) to make the illustrations concise and clear. However, it will be apparent to a person skilled in the art that the first set of nodes 102a and the second set of nodes 102b may include any number of nodes and thus the number of nodes in the first set of nodes 102a and the second set of nodes 102b should not be considered as a limitation of the present disclosure. Further, it will be apparent to a person skilled in the art that each node of the first set of nodes 102a and the second set of nodes 102b is configured to serve one or more functionalities in a manner similar to the functionalities being served by the first node 102aa of the first set of nodes 102a and the first node 102ba of the second set of nodes 102b, respectively.

In some aspects of the present disclosure, the server 106 may be a network of computers, a software framework, or a combination thereof, that may provide a generalized approach to create the server implementation. Examples of the server 106 may include, but are not limited to, personal computers, laptops, mini-computers, mainframe computers, any non-transient and tangible machine that can execute a machine-readable code, cloud-based servers, distributed server networks, or a network of computer systems. The server 106 may be realized through various web-based technologies such as, but not limited to, a Java web-framework, a .NET framework, a hypertext preprocessor (PHP) framework, or any web-application framework.

In some aspects of the present disclosure, the server 106 may be communicatively coupled with each node of the plurality of nodes 102 and may be accessed by each node of the plurality of nodes 102 by way of a device console corresponding to each node of the plurality of nodes 102. In some aspects of the present disclosure, the server 106 may be configured to receive data from the plurality of nodes 102 at a regular interval of time. In other aspects of the present disclosure, the server 106 may be configured to receive data from each node of the plurality of nodes 102 as and when decided by each node of the plurality of nodes 102. In some aspects of the present disclosure, the server 106 may be configured to store a copy of the data corresponding to each node of the plurality of nodes 102 as a backup. In some aspects of the present disclosure, the server 106 may be configured to receive data from each node of the plurality of nodes 102 with a timestamp (hereinafter interchangeably referred to as “a transition” between each node of the plurality of nodes 102 and the server 106). Further, the server 106 may include a look-up table, such that the server 106 may provide metadata corresponding to each transition between each node of the plurality of nodes 102 and the server 106 by way of the look-up table. In other aspects of the present disclosure, a set of centralized or distributed network of peripheral memory devices may be interfaced with the server 106, as an example, on a cloud server. It will be apparent to a person having ordinary skill in the art that the server 106 is for illustrative purposes and not limited to any specific combination of hardware circuitry and/or software. In some aspects of the present disclosure, a data center and/or a stand-alone device may act as one or more nodes of the plurality of nodes 102, such that the data center may include one or more user devices, and the stand-alone device may act as the user device.

FIG. 2 illustrates a block diagram of the first node 102aa of the first set of nodes 102a of the system 100, in accordance with an exemplary aspect of the present disclosure. In some aspects of the present disclosure, the first node 102aa (hereinafter interchangeably referred to and designated as “the first user device 102aa) may be configured to identify a traffic anomaly with respect to the first node 102aa and may be configured to share the traffic anomaly associated with the first user device 102aa with the plurality of nodes 102. In some aspects of the present disclosure, the traffic anomaly may be determined by way of the traffic pattern of the first node 102aa such as, but not limited to, a number of requests from a single source, a rate of connection requests, and unusual traffic patterns, and the like. Preferably, the traffic anomaly may be determined by comparing the traffic pattern at the first node 102aa with the first regular data corresponding to the category of service availed by the first node 102aa.

The first user device 102aa may include a first network interface 202, a first input-output (I/O) interface 204, a first device console 206, a first device processing circuitry 208 and a first device memory 210 communicatively coupled to each other by way of a first communication bus 240.

In some aspects of the present disclosure, the first network interface 202 may be configured to enable communication of the first user device 102aa with each node of the plurality of nodes 102. In some aspects of the present disclosure, the first network interface 202 may be implemented by use of various known technologies to support wired or wireless communication between the first user device 102aa and each node of the plurality of nodes 102 by way of the first communication network 104. The first network interface 202 may further be implemented by use of various known technologies to support wired or wireless communication between the first user device 102aa and the server 106 by way of the second communication network 108. The first network interface 202 may include, but is not limited to, an Ethernet card, a communication port, and/or a Personal Computer Memory Card International Association (PCMCIA) slot and card, an antenna, an antenna, a radio frequency (RF) transceiver, one or more amplifiers, a tuner, one or more oscillators, a digital signal processor, a coder-decoder (CODEC) chipset, a subscriber identity module (SIM) card, and a local buffer circuit. It will be apparent to a person of ordinary skill in the art that the first network interface 202 may include any device and/or apparatus capable of providing wireless or wired communications between the first user device 102aa and each node of the plurality of nodes 102, and the first user device 102aa with the server 106.

In some aspects of the present disclosure, the first I/O interface 204 may be configured to receive and/or convey data from the first user device 102aa to an end user. The first I/O interface 204 may include suitable logic, circuitry, interfaces, and/or code configured to receive inputs and transmit outputs via a plurality of data ports in the first user device 102aa. The first I/O interface 204 may further include various input and output data ports for different I/O devices. Examples of such I/O devices may include, but are not limited to, a touch screen, a keyboard, a mouse, a joystick, a projector audio output, a microphone, an image-capture device, a liquid crystal display (LCD) screen and/or a speaker.

In some aspects of the present disclosure, the first device console 206 may be configured as a computer-executable application, to be executed by the first device processing circuitry 208. In some aspects of the present disclosure, the first device console 206 may include suitable logic, instructions, and/or codes for executing various operations of the first user device 102aa. For example, the first device console 206 may enable the first user to provide the node information through a registration menu (not shown) displayed through the first I/O interface 204. The node information may include, but is not limited to, a selected role (i.e., a consumer of a service and a contributor) traffic data, a category of service, a computation capability, a storage capability, and the like. Aspects of the present disclosure are intended to include and/or otherwise cover any type of the node information associated with a node of the plurality of nodes 102, known to a person having ordinary skill in the art, without deviating from the scope of the present disclosure. In some aspects of the present disclosure, the first device console 206 may be further configured to enable the user to create a login identifier and a password that may enable the user to subsequently login into the system 100. The first device console 206 may be configured to store the node information associated with the user, the login and the password associated with the user in a Look Up Table (LUT) (not shown) provided in the first device memory 210.

In some aspects of the present disclosure, the first device processing circuitry (DPC) 208 may be configured to execute the logic, instructions, and/or codes of the first device console 206 such that the first DPC 208, by way of the first device console 206 detects a DDOS attack through the traffic anomaly in traffic data of the first user device 102aa. The first DPC 208 may be configured to share the traffic anomaly in the traffic data of the first user device 102aa to the plurality of nodes 102. Specifically, the traffic anomaly may be determined based on, but not limited to, a number of requests from a single source, a rate of connection requests, and unusual traffic patterns, and the like. Preferably, the first user device 102aa by way of the first DPC 208 may be configured to share the traffic anomaly in the traffic data of the first user device 102aa to the second set of nodes 102b. In some aspects of the present disclosure, the first DPC 208 may include a first registration engine 212, a first authentication engine 214, a first data share engine 218, the first autoencoding engine 220, a first error engine 222, a first tuning engine 224 and a first smart contract engine 226 communicatively coupled by way of a second communication bus 242. In some aspects of the present disclosure, the first registration engine 212 may be configured to enable the first user device 102aa to register on the system 100 for joining as a node in the plurality of nodes 102. In some aspects of the present disclosure, the first registration engine 212 may be configured as an optimized operating system (OS), an application software or a controller script. Specifically, the first registration engine 212 may be configured to enable the first user to register into the system 100 by providing the node information through a registration menu (not shown) displayed through the first I/O interface 204. The node information may include, but is not limited to, a selected role (i.e., a consumer of a service and a contributor) traffic data, a category of service, a computation capability, a storage capability, and the like. Aspects of the present disclosure are intended to include and/or otherwise cover any type of the node information associated with a node of the plurality of nodes 102, known to a person having ordinary skill in the art, without deviating from the scope of the present disclosure. In some aspects of the present disclosure, the first registration engine 212 may be further configured to enable the user to create a login identifier and a password that may enable the user to subsequently login into the system 100. The first registration engine 212 may be configured to store the node information associated with the user, the login and the password associated with the user in a Look Up Table (LUT) (not shown) provided in the first device memory 210.

The first authentication engine 214 may be configured to authenticate and/or validate the first user device 102aa for joining the plurality of nodes 102. In some aspects of the present disclosure, the first authentication engine 214 may utilize one or more public key infrastructures (PKI) and may facilitate the first user device 102aa to select and/or opt for one of a complete protection or a customized protection against one or more DDOS attacks.

In some aspects of the present disclosure, the system 100 by way of the first registration engine 212 and the first authentication engine 214 may enable a deployment of a new consumer node (i.e., through the first user device 102aa) to the plurality of nodes 102 of the system 100, and thus may facilitate the services of a public distributed network. In some aspects of the present disclosure, upon successful authentication of the new consumer node, the system 100 may facilitate the new consumer node to utilize one or more storage and computation resources of the plurality of nodes 102.

The first data share engine 216 may be configured to enable the first user device 102aa to share the node information to each node of the plurality of nodes 102. In some aspects of the present disclosure, the first data share engine 216 may be configured to receive the first regular data from the distributed ledger (not shown, that may be operationally similar to the first device memory 210), that may be shared by the plurality of nodes 102. In other aspects of the present disclosure, the plurality of nodes 102 may obtain the regular data from the external source (such as the external server).

In some aspects of the present disclosure, the first autoencoding engine 218 may be configured to generate the low dimensional data from the first regular data obtained by the first user device 102aa. In some aspects of the present disclosure, the first autoencoding engine 218 may be configured to generate the low dimensional data by way of one or more AI techniques. The first autoencoding engine 218 may further be configured to generate the second regular data from the low dimensional data. In some aspects of the present disclosure, the first autoencoding engine 218 may be configured to generate the second regular data by way of one or more AI techniques. In some other aspects of the present disclosure, the first autoencoding engine 218 may be configured to generate a new low dimensional data from the traffic data of the first set of nodes 102a. Further, the first autoencoding engine 218 may be configured to generate a new traffic data for the first set of nodes 102a.

Specifically, to train the first autoencoding engine 218, the first error engine 220 may be configured to generate the training reconstruction error. In some aspects of the present disclosure, the first error engine 220 may be configured to compare the first regular data with the second regular data to generate the training reconstruction error. The first tuning engine 222 may be configured to adjust a plurality of parameters of the first autoencoding engine 218 until the training reconstruction error reduces below the third threshold value. In some other aspects of the present disclosure, the first error engine 220 may be configured to generate the reconstruction error by comparing the new low dimensional data with the new traffic data for the first set of nodes 102a. In some aspects of the present disclosure, the first error engine 220 may be configured to generate an alarm in real time when the reconstruction error is above the third threshold value.

In some aspects of the present disclosure, the first tuning engine 222 may be configured to iteratively adjust the plurality of parameters of the first autoencoding engine 218 by way of one or more AI based techniques. In some aspects of the present disclosure, the first smart contract engine 226 may be configured to generate one or more smart contracts for the plurality of nodes to enable the co-operative operation between each node of the plurality of nodes 102. The first token generator 228 may be configured to generate one or more tokens to be used by the plurality of nodes 102 for one or more transactions between the plurality of nodes 102 in leu of one or more services. In some aspects of the present disclosure, the first token generator 228 may generate a predefined number of tokens for the plurality of nodes 102, such that the first set of nodes 102a may transfer one or more tokens to the second set of nodes 102b in leu of the one or more services from the second set of nodes 102b. In some aspects of the present disclosure, the first token generator 228 may facilitate the first user device 102aa with a ‘pay as you go’ scheme, such that the first user device 102aa may pay the second set of nodes 102b only when the first user device 102aa utilizes the one or more services from the second set of nodes 102b.

In some aspects of the present disclosure, the first device memory 210 may be configured to store data corresponding to the plurality of nodes 102 in a distributed manner. The first device memory 210 may include a first user device repository 230, a first traffic data repository 232, a first attack pattern repository 234, a first protocol repository 236 and a first smart contract repository 238. Examples of the first device memory 210 may include but are not limited to, a ROM, a RAM, a flash memory, a removable storage drive, a HDD, a solid-state memory, a magnetic storage drive, a PROM, an EPROM, and/or an EEPROM.

The first user device repository 230 may be configured to store data and/or metadata of the first user device 102aa. The first traffic data repository 232 may be configured to store traffic data of each node of the plurality of nodes 102. The first traffic data repository 232 may further be configured to store a traffic pattern data of each node of the plurality of nodes 102. The first attack pattern repository 234 may be configured to store the set of pre-determined attack patterns and the set of updated attack patterns generated by the plurality of nodes 102. The first protocol repository 236 may be configured to store a pre-defined set of protocols. In some aspects of the present disclosure, the pre-defined set of protocols may be used by the plurality of nodes 102 to segregate genuine traffic from diverted traffic on the first set of nodes 102a using the set of updated attack patterns. The first smart contract repository 238 may be configured to store one or more smart contracts between the plurality of nodes 102 for co-operative operation of the plurality of nodes 102.

In some aspects of the present disclosure, the first user device 102aa may be configured as a virtual machine configured to co-operatively operate in a distributed manner, by sharing computational and storage resources with the plurality of nodes 102. It must be apparent to a person skilled in the art that the virtual machine may be a hardware, that is configured to perform one or more of computation and/or storage tasks.

In some aspects of the present disclosure, the first node 102aa of the first set of nodes 102a may act as a data center, such that the data center may include one or more user devices. It will be apparent to a person skilled in the art that the data center may include any number of user devices without deviating from the scope of the present disclosure. In such scenario, each user device of the data centre is configured to serve one or more functionalities in a manner similar to the functionalities being served by the first user device 102aa of the first set of nodes 102a as described hereinabove.

FIG. 3 illustrates a block diagram of the first node 102ba of the second set of nodes 102b of the system 100, in accordance with an exemplary aspect of the present disclosure. In some aspects of the present disclosure, the first node 102ba of the second set of nodes 102a (hereinafter interchangeably referred to and designated as “the second user device” 102aa) may be configured to identify the traffic anomaly on the first set of nodes 102a and may be configured to segregate genuine traffic from overall traffic diverted on one or more nodes of the first set of nodes 102a to mitigate a DDOS attack associated with the traffic anomaly on the one or more nodes of the first set of nodes 102a. In some aspects of the present disclosure, the second user device 102ba may include a second network interface 302, a second input-output (I/O) interface 304, a second device console 306, a second device processing circuitry (DPC) 308 and a second device memory 310 communicatively coupled to each other by way of a third communication bus 346.

In some aspects of the present disclosure, the second network interface 302 may be configured to enable communication between the second user device 102ba and each node of the plurality of nodes 102. In some aspects of the present disclosure, the second network interface 302 may be implemented by use of various known technologies to support wired or wireless communication between the second user device 102ba and each node of the plurality of nodes 102 by way of the first communication network 104. The second network interface 302 may further be implemented by use of various known technologies to support wired or wireless communication between the second user device 102ba and the server 106 by way of the second communication network 108. Examples of the second network interface 302 may include, but is not limited to, an Ethernet card, a communication port, and/or a Personal Computer Memory Card International Association (PCMCIA) slot and card, an antenna, an antenna, a radio frequency (RF) transceiver, one or more amplifiers, a tuner, one or more oscillators, a digital signal processor, a coder-decoder (CODEC) chipset, a subscriber identity module (SIM) card, and a local buffer circuit. It will be apparent to a person of ordinary skill in the art that the second network interface 302 may include any device and/or apparatus capable of providing wireless or wired communications between the second user device 102ba and each node of the plurality of nodes 102, and the second user device 102ba with the server 106.

In some aspects of the present disclosure, the second I/O interface 304 may be configured to receive and/or convey data from the second user device 102ba to the end user. The second I/O interface 304 may include suitable logic, circuitry, interfaces, and/or code configured to receive inputs and transmit outputs via a plurality of data ports in the second user device 102ba. The second I/O interface 304 may further include various input and output data ports for different I/O devices. Examples of such I/O devices may include, but are not limited to, a touch screen, a keyboard, a mouse, a joystick, a projector audio output, a microphone, an image-capture device, a liquid crystal display (LCD) screen and/or a speaker.

In some aspects of the present disclosure, the second device console 306 may be configured as a computer-executable application, to be executed by the second device processing circuitry (DPC) 308. In some aspects of the present disclosure, the second device console 306 may include suitable logic, instructions, and/or codes for executing various operations of the second user device 102ba. For example, the second device console 306 may enable the second user to provide the node information through a registration menu (not shown) displayed through the first I/O interface 304. The node information may include, but is not limited to, a selected role (i.e., a consumer of a service and a contributor) traffic data, a category of service, a computation capability, a storage capability, and the like. Aspects of the present disclosure are intended to include and/or otherwise cover any type of the node information associated with a node of the plurality of nodes 102, known to a person having ordinary skill in the art, without deviating from the scope of the present disclosure. In some aspects of the present disclosure, the second device console 306 may be further configured to enable the user to create a login identifier and a password that may enable the user to subsequently login into the system 100. The second device console 306 may be configured to store the node information associated with the user, the login and the password associated with the user in a Look Up Table (LUT) (not shown) provided in the second device memory 310.

In some aspects of the present disclosure, the second device processing circuitry (DPC) 308 may be configured to execute the logic, instructions, and/or codes of the second device console 306 such that the second DPC 308, by way of the second device console 306 may be configured to detect a DDOS attack by way of the traffic anomaly of the first user device 102aa. The second DPC 308 may further be configured to segregate the genuine traffic from overall traffic that is diverted on the first set of nodes 102a to mitigate a DDOS attack associated with the traffic anomaly on the first set of nodes 102a. In some aspects of the present disclosure, the second device processing circuitry (DPC) 308 may include a second registration engine 312, a second authentication engine 314, a second data share engine 316, a second autoencoding engine 318, a second error engine 320, a second segregation engine 322, a pattern selection engine 324, a pattern generation engine 326, a traffic management engine 328 and a second smart contract engine 330 communicatively coupled by way of a fourth communication bus 348.

In some aspects of the present disclosure, the second registration engine 312 may be configured to enable the second user device 102ba to register on the system 100 for joining the plurality of nodes 102. In some aspects of the present disclosure, the first registration engine 212 may be configured as an optimized operating system (OS), an application software or a controller script. Specifically, the second registration engine 312 may be configured to enable the second user device 102ba to register on the system 100 for joining as a node in the plurality of nodes 102. Specifically, the second registration engine 312 may be configured to enable the second user to register into the system 100 by providing the node information through a registration menu (not shown) displayed through the second I/O interface 304. The node information may include, but is not limited to, a selected role (i.e., a consumer of a service and a contributor) traffic data, a category of service, a computation capability, a storage capability, and the like. Aspects of the present disclosure are intended to include and/or otherwise cover any type of the node information associated with a node of the plurality of nodes 102, known to a person having ordinary skill in the art, without deviating from the scope of the present disclosure. In some aspects of the present disclosure, the second registration engine 312 may be further configured to enable the user to create a login identifier and a password that may enable the user to subsequently login into the system 100. The second registration engine 312 may be configured to store the node information associated with the user, the login and the password associated with the user in a Look Up Table (LUT) (not shown) provided in the second device memory 310.

The second authentication engine 314 may be configured to authenticate and/or validate the second user device 102ba for joining the plurality of nodes 102. In some aspects of the present disclosure, the second authentication engine 314 may utilize one or more public key infrastructures (PKI) and may facilitate the second user device 102ba to select or opt for one of a complete protection or a customized protection against one or more DDOS attacks. In some aspects of the present disclosure, the system 100 by way of the second registration engine 312 and the second authentication engine 314 may enable a deployment of a new processor node (i.e., through the second user device 102ba) to the plurality of nodes 102 of the system 100, and thus may facilitate a public distributed network. In some aspects of the present disclosure, upon successful authentication of the new processor node, the system 100 may facilitate the new processor node to utilize one or more storage and computation resources of the plurality of nodes 102.

The second data share engine 316 may be configured to enable the second user device 102ba to receive the node information associated with the first set of nodes 102a of the plurality of nodes 102. The node information associated with the first set of nodes 102a may include traffic data, computation capabilities and storage capabilities of the first set of nodes 102a. In some aspects of the present disclosure, the second data share engine 316 may be configured to receive the first regular data from the distributed ledger (not shown, that may be operationally similar to the second device memory 310), that may be shared by the plurality of nodes 102. In other aspects of the present disclosure, the plurality of nodes 102 may obtain the regular data from the external source (such as the external server). In some other aspects of the present disclosure, the second data share engine 316 may be configured to share the set of updated attack patterns to the plurality of nodes 102. The second autoencoding engine 318 may be configured to generate the low dimensional data from the first regular data. In some aspects of the present disclosure, the second autoencoding engine 318 may be configured to generate the low dimensional data by way of one or more AI techniques. The second autoencoding engine 318 may further be configured to generate the second regular data from the low dimensional data. In some aspects of the present disclosure, the second autoencoding engine 318 may be configured to generate the second regular data by way of one or more AI techniques. In some aspects of the present disclosure, the second autoencoding engine 318 may be configured to generate a new low dimensional data from the traffic data of the first set of nodes 102a. Furthermore, the second autoencoding engine 318 may be configured to generate a new traffic data for the first set of nodes 102a.

The second error engine 320 may be configured to generate the training reconstruction error. In some aspects of the present disclosure, the second error engine 320 may be configured to compare the first regular data with the second regular data to generate the training reconstruction error. The first tuning engine 222 may be configured to adjust a plurality of parameters of the first autoencoding engine 218 until the training reconstruction error reduces below the third threshold value. In some other aspects of the present disclosure, the second error engine 320 may be configured to generate the reconstruction error by comparing the new low dimensional data with the new traffic data for the first set of nodes 102a. In some aspects of the present disclosure, the second tuning engine 322 may be configured to iteratively adjust the plurality of parameters of the second autoencoding engine 318 by way of one or more AI based techniques. Specifically, the autoencoding engines of each node of the plurality of nodes 102 (e.g., the first autoencoding engine 218 and the second autoencoding engine 318) may be cooperatively trained by way of one or more AI based techniques provide an accurate model to mitigate DDOS attacks.

The first set of nodes 102 may be configured to share the set of anomalies with the plurality of nodes 102. The pattern selection engine 326 may be configured to select one attack pattern from the set of pre-determined attack patterns for each traffic anomaly from the set of anomalies having the similarity score higher than a second threshold value. In some aspects of the present disclosure, when a number of attack patterns from the set of pre-determined attack patterns have the similarity score greater than the second threshold value, the attack pattern with the highest similarity score is selected. In some aspects of the present disclosure, if no attack pattern of the set of pre-determined attack patterns results in the similarity score higher than the second threshold value, the pattern generation engine 328 may be configured to generate a new pattern for each traffic anomaly of the first set of nodes 102a. The pattern generation engine 328 may further generate the set of updated attack patterns. The traffic management engine 330 may be configured to segregate genuine traffic from the overall traffic that is diverted to the first set of nodes 102a using the set of updated attack patterns. In some aspects of the present disclosure, the traffic management engine 330 may be configured to segregate genuine traffic from the overall traffic that is diverted to the first set of nodes 102a by way of GRE tunnelling technique. The second smart contract engine 332 may be configured to generate one or more smart contracts for the plurality of nodes to enable the co-operative operation between each node of the plurality of nodes 102. The second token generator 334 may be configured to generate one or more tokens to be used by the plurality of nodes 102 for one or more transactions between the plurality of nodes 102 in leu of one or more services. In some aspects of the present disclosure, the second token generator 334 may generate the predefined number of tokens for the plurality of nodes 102, such that the first set of nodes 102a may transfer one or more tokens to the second set of nodes 102b in leu of the one or more services from the second set of nodes 102b. In some aspects of the present disclosure, the second token generator 334 may facilitate the second user device 102ba with the ‘pay as you go’ scheme, such that the first set of nodes 102a may pay the second user device 102ba only when the first set of nodes 102a may utilize the one or more services from the second user device 102ba.

The second device memory 310 may be configured to store data corresponding to the plurality of nodes 102 in the distributed manner. The second device memory 310 may include a second user device repository 336, a second traffic data repository 338, a second attack pattern repository 340, a second protocol repository 342 and a second smart contract repository 344. Examples of the second device memory 310 may include but are not limited to, a ROM, a RAM, a flash memory, a removable storage drive, a HDD, a solid-state memory, a magnetic storage drive, a PROM, an EPROM, and/or an EEPROM.

The second user device repository 336 may be configured to store data and/or metadata of the second user device 102ba. The second traffic data repository 338 may be configured to store traffic data of each node of the plurality of nodes 102. The second traffic data repository 340 may further be configured to store a traffic pattern data of each node of the plurality of nodes 102. The second attack pattern repository 342 may be configured to store the set of pre-determined attack patterns and the set of updated attack patterns generated by the plurality of nodes 102. The second protocol repository 342 may be configured to store a pre-defined set of protocols. In some aspects of the present disclosure, the pre-defined set of protocols may be used by the plurality of nodes 102 to segregate genuine traffic from diverted traffic on the first set of nodes 102a using the set of updated attack patterns. The second smart contract repository 344 may be configured to store one or more smart contracts between the plurality of nodes 102 for co-operative operation of the plurality of nodes 102.

In some aspects of the present disclosure, the second user device 102ba may be configured as a virtual machine configured to co-operatively operate in a distributed manner, by sharing computational and storage resources with the plurality of nodes 102. It must be apparent to a person skilled in the art that the virtual machine may be a hardware, that is configured to perform one or more of computation and/or storage tasks.

In some aspects of the present disclosure, the second node 102ba of the first set of nodes 102a may act as a data center, such that the data center may include one or more user devices. It will be apparent to a person skilled in the art that the data center may include any number of user devices without deviating from the scope of the present disclosure. In such scenario, each user device of the data centre is configured to serve one or more functionalities in a manner similar to the functionalities being served by the second user device 102ba of the second set of nodes 102b as described hereinabove.

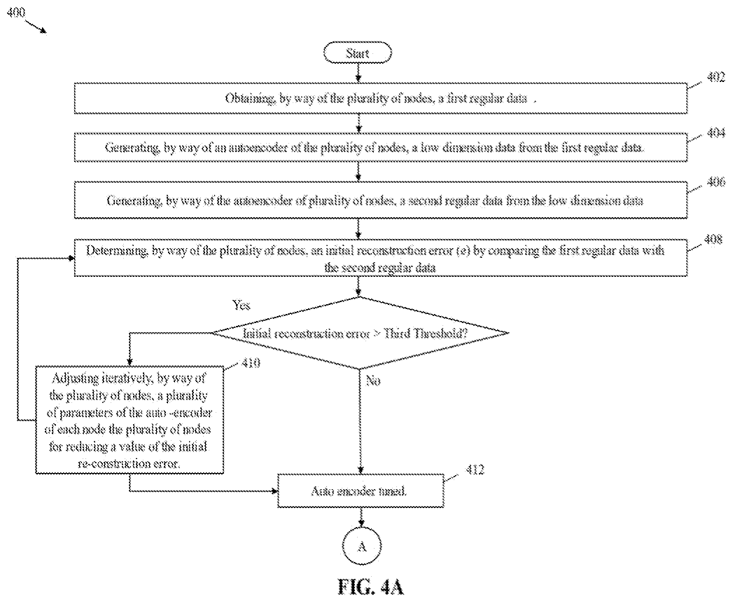

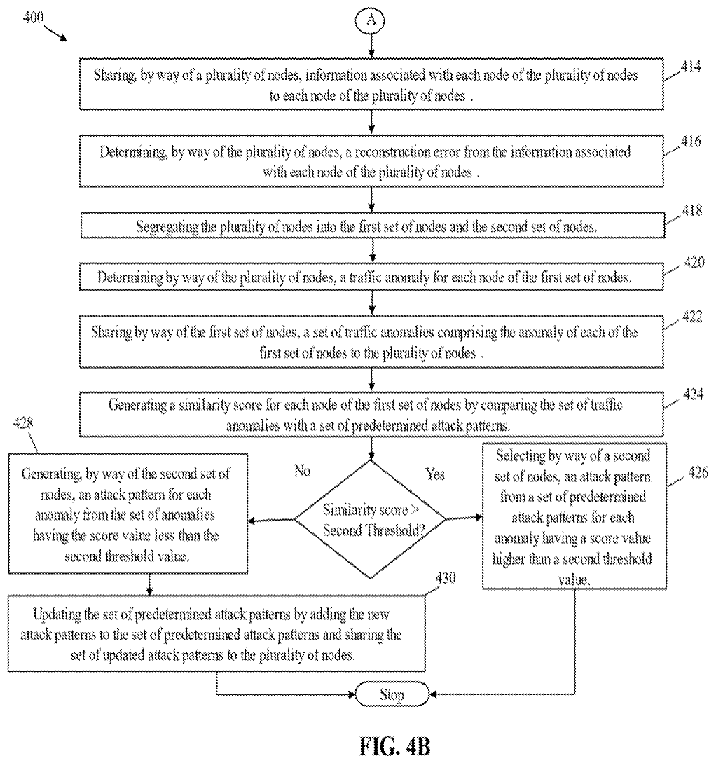

FIGS. 4A-4B illustrate a flow diagram of a method 400 for mitigating DDOS attacks, in accordance with an exemplary aspect of the present disclosure.

At step 402, the system 100 by way of the plurality of nodes 102 may be configured to obtain or fetch the first regular data. In some aspects of the present disclosure, the plurality of nodes 102 may be configured to receive the first regular data from the distributed ledger (not shown) that may be shared by the plurality of nodes 102. In other aspects of the present disclosure, the plurality of nodes 102 may obtain the regular data from the external source (such as the external server).

At step 404, the system 100 by way of the autoencoding engine of plurality of nodes 102 may be configured to generate the low dimensional data from the first regular data. In some aspects of the present disclosure, the plurality of nodes 102 may generate the low dimensional data from the first regular data by way of one or more AI techniques.

At step 406, the system 100 by way of the autoencoding engine of plurality of nodes 102 may be configured to generate the second regular data from the low dimensional data. In some aspects of the present disclosure, the plurality of nodes 102 may generate the second regular data from the low dimensional data by way of one or more AI techniques.

At step 408, the system 100 by way of the plurality of nodes 102 may be configured to determine the training reconstruction error by comparing the first regular data with the second regular data. The system 100 at step 408 by way of the plurality of nodes 102 may further be configured to compare the training reconstruction error with the third threshold value.

At step 410, when the training reconstruction error is greater than the third threshold value, the system 100 by way of the plurality of nodes 102 may be configured to iteratively adjust Adjusting the plurality of parameters of the autoencoding engine of each node the plurality of nodes 102 for reducing a value of the training reconstruction error below the third threshold value.

At step 412, based on the iterations at step 410, the system 100 is configured to tune the parameters of autoencoding engine of the plurality of nodes 102.

Specifically, the steps 402 through 412 may be configured for training the autoencoding engine of the plurality of nodes 102.

At step 414, the system 100 by way of the plurality of nodes 102 may be configured to share the information associated with each node of the plurality of nodes 102 to each other node of the plurality of nodes 102.

At step 416, the system 100 by way of the plurality of nodes 102 may be configured to determine a reconstruction error from the information associated with each node of the plurality of nodes 102. In some aspects of the present disclosure, to determine the reconstruction error for each node of the plurality of nodes 102, the system 100 may be configured to compare the traffic data of each node of the plurality of nodes 102 with the first regular data corresponding to the category of service of each node of the plurality of nodes 102.

At step 418, the system 100 by way of the plurality of nodes 102 may be configured to segregate the plurality of nodes 102 into the first set of nodes 102a and the second set of nodes 102b. Preferably, at step 418, the system 100 by way of the plurality of nodes 102 may be configured to compare the reconstruction error of each node of the plurality of nodes 102 with the first threshold value. In some aspects of the present disclosure, the nodes of the plurality of nodes 102 having reconstruction error higher than the first threshold value are segregated as the first set of nodes 102a (i.e., consumer nodes) and the nodes of the plurality of nodes 102 having reconstruction error lower than the first threshold value are segregated as the second set of nodes 102b (i.e., producer nodes).

At step 420, the system 100 by way of the plurality of nodes 102 may be configured to determine the traffic anomaly for each node of the first set of nodes 102a. In some aspects of the present disclosure, the system 100 may be configured to determine the traffic anomaly for each node of the first set of nodes 102a using the traffic data of each node of the first set of nodes 102a.

At step 422, the system 100 by way of the first set of nodes 102a may be configured to share the set of anomalies comprising the traffic anomaly of each node of the first set of nodes 102a to the plurality of nodes 102.

At step 424, the system 100 by way of the second set of nodes 102b may be configured to generate the similarity score for each node of the first set of nodes 102a by comparing the set of anomalies with the set of pre-determined attack patterns. In some aspects of the present disclosure, at step 424, the system 100 may further be configured to compare the similarity score for each node of the first set of nodes 102a with the second threshold value.

At step 426, the system 100 by way of the second set of nodes 102b may be configured to select an attack pattern from the set of pre-determined attack patterns for each traffic anomaly having the similarity score higher than a second threshold value. If any node of the first set of nodes has more than one similarity scores higher than the second threshold value, the system 100 may be configured to select the highest similarity score of the more than one similarity scores higher than the second threshold value.

At step 428, if the similarity score of one or more nodes of the first set of nodes 102a is less than the second threshold value, the system 100 by way of the second set of nodes 102b may be configured to generate a new set of attack pattern comprising a new attack pattern for each traffic anomaly from the set of anomalies having the similarity score less than the second threshold value.

At step 430, the system 100 by way of the second set of nodes 102b may be configured to update the set of pre-determined attack patterns by adding the new attack patterns to the set of pre-determined attack patterns. The system 100 by way of the second set of nodes 102b may further be configured to share the set of updated attack patterns to the plurality of nodes.

In some aspects of the present disclosure, the system 100 by way of the second set of nodes 102b may be configured to segregate the genuine traffic from the fake traffic on the first set of nodes 102a using the set of updated attack patterns. In some aspects of the present disclosure, the system 100 by segregating the traffic from the system 100 by way of the first set of nodes 102a may be configured to mitigate DDOS attacks from the first set of nodes 102a.

As will be readily apparent to those skilled in the art, aspects of the present disclosure may easily be produced in other specific forms without departing from their essential characteristics. Aspects of the present disclosure are, therefore, to be considered as merely illustrative and not restrictive, the scope being indicated by the claims rather than the foregoing description, and all changes which come within therefore intended to be embraced therein.

As one skilled in the art will appreciate, the system 100 includes a number of functional blocks in the form of a number of units and/or engines. The functionality of each unit and/or engine goes beyond merely finding one or more computer algorithms to carry out one or more procedures and/or methods in the form of a predefined sequential manner, rather each engine explores adding up and/or obtaining one or more objectives contributing to an overall functionality of the system 100. Each unit and/or engine may not be limited to an algorithmic and/or coded form, rather may be implemented by way of one or more hardware elements operating together to achieve one or more objectives contributing to the overall functionality of the system 100. Further, as it will be readily apparent to those skilled in the art, all the steps, methods and/or procedures of the system 100 are generic and procedural in nature and are not specific and sequential.

Certain terms are used throughout the following description and claims to refer to particular features or components. As one skilled in the art will appreciate, different persons may refer to the same feature or component by different names. This document does not intend to distinguish between components or features that differ in name but not structure or function. While various aspects of the present disclosure have been illustrated and described, it will be clear that the present disclosure is not limited to these aspects only. Numerous modifications, changes, variations, substitutions, and equivalents will be apparent to those skilled in the art, without departing from the spirit and scope of the present disclosure, as described in the claims.

We claim:

1. A system (100) to mitigate distributed denial of service (DDOS) attacks, the system (100) comprising:
a plurality of nodes (102) configured to (i) exchange node information with one another, (ii) determine a reconstruction error from the node information associated with each node of the plurality of nodes (102), and (iii) determine a set of traffic anomalies for a first set of nodes (102a) of the plurality of nodes (102) having the reconstruction error higher than a first threshold value;
a second set of nodes (102a) of the plurality of nodes (102) are configured to (i) select a predetermined attack pattern from a set of predetermined attack patterns for each traffic anomaly from the set of traffic anomalies having a similarity score higher than a second threshold value, (ii) generate an new attack pattern for each traffic anomaly of the set of traffic anomalies having the similarity score less than the second threshold value, and (iii) segregate genuine traffic from overall traffic that is diverted at the first set of nodes (102a) using one of, the set of predetermined attack patterns and the new attack pattern.

2. The system (100) as claimed in claim 1, wherein to segregate the genuine traffic from the traffic at the first set of nodes (102a), the plurality of nodes (102) is configured to update the set of predetermined attack patterns by adding the new attack pattern to the set of predetermined attack patterns.

3. The system (100) as claimed in claim 1, wherein the plurality of nodes (102) is further configured to (i) obtain first regular data, (ii) generate low dimensional data from the first regular data, (iii) generate second regular data from the low dimensional data, (iv) determine an training reconstruction error by comparing the first regular data with the second regular data, and (v) iteratively adjust a set of weights of the plurality of nodes (102) for reducing a value of the training re-construction error below a third threshold value using one or more artificial intelligence (AI) techniques.

4. The system (100) as claimed in claim 1, wherein the plurality of nodes (102) are segregated into the first and second set of nodes (102a-102b) based on node information associated with each node of the plurality of nodes (102).

5. The system (100) as claimed in claim 1, wherein to generate the similarity score, the second set of nodes (102b) is configured to compare the traffic anomaly of each node of the first set of nodes (102a) with each attack pattern of the set of predetermined attack patterns.

6. A method (400) for mitigating distributed denial of service (DDOS) attacks, the method (400) comprising:
exchanging, by way of a plurality of nodes (102), node information within each other;
determining, by way of the plurality of nodes (102), a reconstruction error from the node information associated with each node of the plurality of nodes (102);
determining, by way of the plurality of nodes (102), a set of traffic anomalies for a first set of nodes (102a) of the plurality of nodes (102) having the reconstruction error higher than a first threshold value;
selecting, by way of a second set of nodes (102b), a predetermined attack pattern from a set of predetermined attack patterns for each traffic anomaly from the set of traffic anomalies having a similarity score higher than a second threshold value;
generating, by way of the second set of nodes (102b), an attack pattern for each traffic anomaly of the set of traffic anomalies having the similarity score less than the second threshold value; and
segregating, by way of the second set of nodes (102b), genuine traffic from overall traffic that is diverted at the first set of nodes (102a) using the set of predetermined attack patterns.

7. The method (400) as claimed in claim 6, wherein for segregating the genuine traffic from diverted traffic on the first set of nodes (102a), the method (400) comprising updating the set of predetermined attack patterns by adding the attack pattern for each traffic anomaly of the set of traffic anomalies having the similarity score less than the second threshold value to the set of predetermined attack patterns.

8. The method (400) as claimed in claim 6, further comprising:
obtaining, by way of the plurality of nodes (102), first regular data;
generating by way of the plurality of nodes (102), a low dimensional data from the first regular data;
generating, by way of the plurality of nodes (102), second regular data from the low dimensional data;
determining, by way of the plurality of nodes (102), an training reconstruction error by comparing the first regular data with the second regular data; and
adjusting iteratively, by way of the plurality of nodes (102), a set of weights of the plurality of nodes (102) for reducing a value of the training re-construction error below a third threshold value using one or more artificial intelligence (AI) techniques.

9. The method (400) as claimed in claim 6, wherein for determining the traffic anomaly for each node of the first set of nodes (102a), the method (400) comprising segregation of the plurality of nodes (102) into the first and second set of nodes (102a-102b) based on the node information associated with each node of the plurality of nodes (102), by way of the plurality of nodes (102).

10. The method (400) as claimed in claim 6, further comprising generating the similarity score by comparing, by way of the second set of nodes (102b), the traffic anomaly of each node of the first set of nodes (102a) with each attack pattern of the set of pre-determined attack patterns.
